(19) United States
(12) Patent Application Publication
(10) Pub. No.: US 2009/0101711 A1
(43) Pub. Date: Apr. 23, 2009

(54) Secure Delivery of Goods

(75) Inventor: Robert Grayson, Buckinghamshire (GB)

Correspondence Address: K&L Gates LLP, STATE STREET FINANCIAL CENTER, One Lincoln Street, BOSTON, MA, 02111-2950, US

(73) Assignee: Delivery Works Limited, London (GB)

(21) Appl. No.: 11/918,377

(22) PCT Filed: Apr. 12, 2006
(86) PCT No.: PCT/GB2006/050083

§ 371 Date: Dec. 23, 2008

(30) Foreign Application Priority Data
Apr. 14, 2005 (GB) 0507545.2

(51) Int. Cl. G06K 7/01

(52) U.S. Cl. 235/382.5

(57) ABSTRACT

A secure container (2) has a combination lock (6) that is always operable in response to at least one master key and is also operable on a single occasion in response to a transaction-unique delivery key generated from the master key. The lock (6) also contains processor means (20) for comparing or decoding the delivery key, means (10, 20, 26) for releasing the lock in response to a valid delivery key, and storage means (22) for identifying used delivery keys.

### BACKGROUND OF THE INVENTION

The present invention relates to the secure delivery of goods ordered from a seller to a customer via a carrier. In the context of this specification the term seller is not restricted to business to consumer retail sales but is to be understood as any seller to a customer who is not necessarily present to accept delivery. The present invention therefore also relates to business to business sales.

### TECHNICAL PROBLEM

The home delivery problem presently restricts the growth of internet sales. The problem also arises in the context of traditional mail order or any other remote purchasing mechanic.

Internet retail sales are reliant on the efficient and effective delivery of goods to customers. The need for customers to be available or to make arrangements to accept goods too large for delivery through a standard letterbox is an inconvenience potentially deterring customers from making internet retail purchases. If the customer is not available to accept the goods, the goods are often not delivered and returned to the distribution point. A new date for delivery must then be scheduled or the customer has to collect the goods from a central location, such as the carrier's depot. From a seller's perspective, requesting a carrier to deliver goods to a customer at an allocated time on a specified date is inefficient and expensive.

There are currently businesses that provide services for the delivery of all manner of goods ordered online. These services allow customers to select delivery dates and times, but often include restrictive time windows for delivery and/or high delivery costs. Other delivery services, such as courier services or the postal network also tend to operate within strict logistical parameters, where delivery is optimised to reduce the carrier's costs and not to the needs of the customer.

The present invention addresses the problem of the reliance on co-ordination between the customer and the carrier for the effective and efficient delivery of goods.

### PRIOR ART SOLUTIONS

It has already been proposed to solve this problem by the use of a secure container accessible to both the customer and the carrier, such that goods can be delivered while the customer is absent.

For example DE19939744 (Bernd Keiderling) suggests a door to a goods enclosure with an electrically operated lock that can be operated by a biometric key that identifies the delivery person. Such a system requires not only the use of a specific carrier but also a specific delivery person and therefore is unsuitable for more than one retailer-customer relationship.

The concept of a lock that is responsive to a numeric key is known in the art. For example key-pad operated or other combination locks are in common use. The numeric key that operates such a combination lock can be reprogrammed. Hotel room safes are also typically now settable by swiping a credit card through a magnetic stripe reader that uses the credit card number as the key. Combination locks can also be made to respond to a variety of inputs. For example US2002103653 (Stephen Huxter) suggests an automated collection point to which goods can be delivered and which is accessible to customers by different types of interfaces, such as barcode readers, smart card readers, biometric scanners or keypads.

U.S. Pat. No. 6,769,611 (Miller et al) discloses a method and apparatus for securely ordering and taking delivery of goods that employs a secure container having a barcode-operated combination lock. When the customer places an online order, the retailer generates an unlock code for the ordered goods. This unlock code is sent by email to the customer to print out as a barcode and use for opening the lock on the secure container. The seller also distributes the unlock code to the carrier to use for opening the lock on the secure container when the goods are delivered.

This system requires the customer to have the facility and time to print barcodes. The customer also needs to use both a master code and a supplier-generated consignment delivery code sent from the retailer to prime the barcode reader within the lock of the secure container every time a delivery is expected. This is time consuming and inconvenient. The system will make it logistically difficult, for example, for a customer to order something online at work for same day delivery at a home address.

GB2368881 (Jergen Beider) also appreciates the utility of a secure container with a combination lock operable by distinct keys supplied to the carrier and customer. In this proposal the container is itself connected to the internet in order for its lock to be controlled. Remotely controlled locker banks of this nature are also in commercial operation. See http://www.bybox.com/. This system does not provide a personal container but requires the customer to travel to a remote locker bank.

GB 2372126A (Coded Access) describes a failed attempt to establish a delivery system using a combination lock which is always operable in response to a master pin code and also operable in response to access codes generated by a server. Single use access codes are described. The lock contains a processing unit and has a memory capable of storing used access codes. While Coded Access appreciated the desirability of eliminating the communications link between lock and system server, the system requires an elaborate system for authentication of those requesting access codes for a specific lock. For example it is necessary to pre-register authorised requesters by lodging various identification items such as likely mobile phone numbers. The system uses time-based access validity and this requires clocks in the server and the lock to remain in sync.

The present invention aims to solve the technical problem of providing a cost-effective solution that would enable a customer (whether a business or an individual) of many internet sellers to use or subscribe to a system permitting the use of a low maintenance secure delivery system personal to them.

### SOLUTION OF THE INVENTION

The present invention accordingly provides a combination lock providing access to a delivery space, which lock is always operable in response to at least one master key and also operable on a single occasion in response to a transaction-unique delivery key, characterised in that the transaction-unique delivery key is generated from a portion of the master key, and in that the lock comprises processor means for validating the delivery key, means for releasing the lock in response to a valid delivery key, and storage means for identifying used delivery keys.

By incorporating some minimal processing in the lock itself, the invention eliminates the need to prime the lock for each delivery as required by the Miller system. The use of a transaction unique key generated from a portion of the master key effectively eliminates the Coded Access need for a further authentication of the requester of an access code. The system of the present invention provides owner-driven access as the placing of an order using a personal credit card automatically guarantees authenticated access to the “owner” of the lock. In order to ensure that the lock is always operable in response to the master key, the lock can be initialised in a simple once only setup process. Where the owner wishes to use multiple cards with the lock each becomes a separate master key.

The system maintains the advantage that the lock does not need to communicate with any central server or scheme operator. The system does not require any clock synchronisation either. It is also unnecessary to provide for any visible unique identifier on the face of the lock as suggested by Coded Access.

Such a lock can be applied to a secure container as suggested by Miller or to a door to a room or building that provides the required delivery space.

The delivery key may operate the lock only once or allow re-opening of the lock during a predetermined time period after initial use and both of these options are deemed to be operating the lock on a single occasion.

Preferably the lock may be programmed by a payment card having a number, a portion of which then becomes the master key.

Preferably the releasing means comprises a barcode reader and the delivery key is a barcode.

The invention also provides a method for the secure delivery of goods to or from a customer having access to a delivery space secured with such a combination lock, comprising the steps of

(i) programming the lock with a master key
(ii) ordering of goods or services by the customer from a seller using a master key;
(iii) generation of a transaction-unique delivery key from a portion of the master key and data identifying the seller and transaction;
(iv) printing of the delivery key onto the goods as a barcode;
(v) delivery of the goods to the secure container by a carrier;
(vi) reading of the delivery key by the lock;
(vii) release of the lock in response to a valid delivery key to enable the carrier to place goods into or remove them from the delivery space; and
(viii) storing data identifying the used delivery key in the lock.

### ADVANTAGES OF THE INVENTION

Where the master key is part of the serial number or other details contained on the customer's credit card, such as the issue date, expiry date or security code, it is extremely straightforward for the customer to use the system as his or her only investment is in the acquisition and programming of the lock and possibly a container to serve as the delivery space, if an existing garage or shed having a door to which the lock can be fitted is not available or suitable. The credit card number remains secure as only a portion—say the first 12 digits is needed as a master key for the lock. In a business to business application the master key can be a serial number pre-programmed into the lock and also supplied on a number of card keys that operate the lock.

The details of the master key are used by the seller to generate a delivery key which is transaction unique and identifies the order from initiation to delivery. The delivery key can be used by both the carrier and the seller in a way which fully integrates with their own tracking and processing systems. The customer does not need to receive any codes from the seller as in the Miller scheme in order to prime or access the lock. The customer is also able to track the delivery process and access the delivery space simply by using his own credit card. The lock only needs to be programmed once, at the point when the customer acquires it. For all subsequent purchases, once the order is made, no further participation from the customer is required except to collect the goods once delivered.

### BRIEF DESCRIPTION OF THE DRAWINGS

In order that the invention may be well understood some embodiments thereof will now be described, by way of example only, with reference to the accompanying diagrammatic drawings, in which

FIG. 1 illustrates a secure container with a lock in accordance with the invention;

FIG. 2 is a block diagram of the electronics in the combination lock;

FIG. 3 is a schematic diagram illustrating the principle of delivery key generation; and

FIG. 4 is a schematic diagram illustrating the process for the secure delivery of goods in accordance with the invention.

### DETAILED DESCRIPTION OF A PREFERRED EMBODIMENT

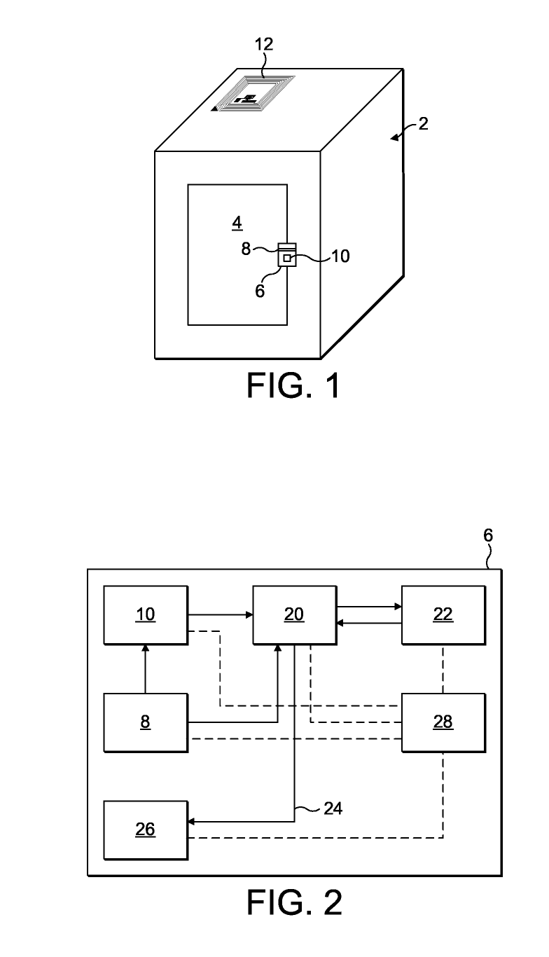

As shown in FIG. 1, a secure container 2 has a hinged access door 4 fastened by a latch (not shown) releasable by a lock 6. The lock 6 is provided with a swipe slot 8 by means of which a payment card having a magnetic stripe can be read. For use with “Chip and Pin” cards the slot 8 would need to be able to read the Chip. A barcode reader 10 is also provided. The reader 10 is shown on the lock 6 but could be positioned anywhere on or adjacent to the container provided its output can be connected to the lock electronics as described below.

The secure container 2 is a box of durable material such as metal or plastic that can be fixed securely in a location at a customer's delivery address. The container provides a delivery space. The container could, for example, be built into a wall in the manner of containers for utility meters. The container 2 is provided with means for advertising its presence such as an RFID tag or GPS tracking locator 12.

The door 4 can be on any of the faces of the container 2 and is securely fastened by the latch of lock 6.

The lock 6 can be a padlock (loose relative to the container) or a fixed lock as shown.

The lock 6 could also be fitted to a door that gives access to an alternative delivery space such as the interior of a shed, garage or storage room.

The lock 6 is shown as having a swipe slot 8 so that it can be programmed with its master key by reading a magnetic stripe on a payment card. In an alternative embodiment the lock may have a keypad or keyboard to program in the master key or may read the master key using its barcode reader 10 making the swipe slot 8 redundant. The reader 10 may also be capable of reading an RFID tag that could be used in place of a barcode on the delivered object.

As shown in FIG. 2, the lock 6 contains a processor 20, which receives inputs from the swipe slot 8 and the barcode or RFID tag reader 10. A memory 22 is connected to the processor. The processor 20 also has an output 24 that controls a latch actuator 26. The memory 22 stores a control program for the processor 20 and a look up table used for the validation of transaction-unique delivery keys. The memory 22 is sufficiently large to enable the lock 6 to recognise at least 10,000 transaction-unique delivery keys. This ensures that the lock will function for a considerable period without the need for any maintenance. The use of non volatile EPROM memory is preferred so that data is not lost in the event of a power failure. A power supply 28 is also provided to provide power to the swipe slot 8, barcode reader 10, processor 20, memory 22 and latch actuator 26.

The power supply 28 may be a battery, solar cell or other energy source. Where a battery is used to power the lock, an indicator is provided on the face of the lock to indicate when battery power is low and the batteries need to be replaced. In the event of power failure the lock will fail closed. Once the batteries have been replaced, the lock can be opened in the normal way.

The lock is also provided with means for interrogating the memory to carry out delivery investigations.

In order for the lock to be supplied in a locked condition each lock will contain a unique electronic serial number. The lock would be supplied with the door closed and accompanied by a unique barcode key generated from the electronic serial number for use before the lock is programmed with the customer's master key.

### Method of Use

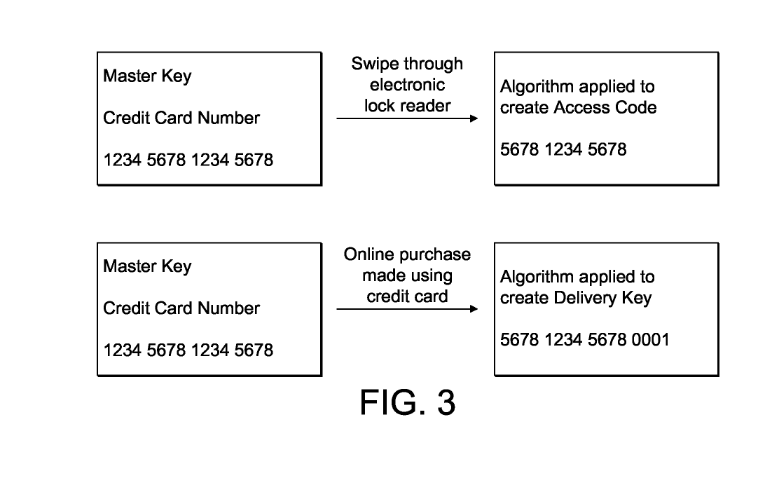

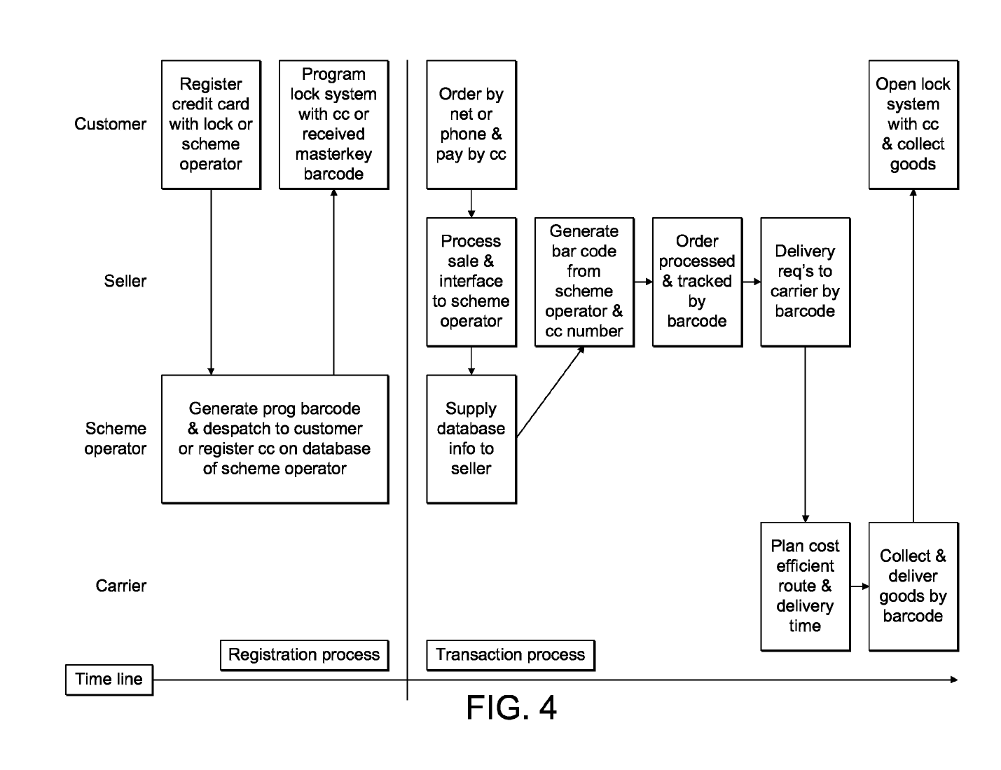

The customer may own a payment card or may acquire one on acquisition of the combination lock 6 or secure container 2. As illustrated in FIG. 3 the master key is created by swiping the payment card through the swipe slot 8 to generate an access code. In this example the processor simply ignores the first four digits of the credit card number to create an access code which will allow the credit card to become the master key and open the lock whenever that master key is presented to the lock via the swipe slot. The access code is stored in the memory 22. The master key could also be programmed in via a keypad or keyboard. The lock can accept more than one master key so that it can be used by the customer with several payment cards. Any payment card can be used with the system as it is the seller or carrier who is registered with the scheme operator.

In a second variant of the registration process for the scheme, the customer can register his credit cards with the scheme operator, who then produces a master key for each card. These keys are then sent to the customer in the form of a barcode which is scanned by the reader 10 in the lock. These barcodes are then used to open the lock for the customer. The advantage of this embodiment is that the master key barcode is used instead of the originating card and it removes the need for a card reader, thus reducing the cost of the lock itself.

When the customer makes a purchase from a seller participating in the scheme, he supplies the master key to the seller or scheme operator. The master key is used together with other transaction related data to create, via a simple one-way algorithm such as SHA-1 (Secure Hash Algorithm 1), a transaction-unique delivery key. The other data may include the valid till or issue date and/or security code of the payment card.

This delivery key is at least a twelve-digit number that can be printed in the form of a barcode or any other form of electronic labelling such as an RFID tag. The seller may add further digits to the delivery key which identify, for example, a date and time for delivery.

The goods are passed by the seller to the carrier. The presence of an RFID tag or GPS tracking locator 12 in the container helps the carrier locate its exact position. This eliminates the need for the container to be prominently displayed attracting unwanted attention from opportunist thieves. The carrier delivers the goods to the delivery address and presents the barcode to the barcode reader 10 on the lock 6. Similarly, if the package is labelled with an RFID tag, this is read by the reader 10. The processor 20 is programmed to validate the transaction-unique delivery key. This may be done, for example, by extracting the scrambled master key portion from the transaction-unique delivery key. This master key portion must be recognised by the processor 20. The transaction-unique delivery key is also compared to the valid keys stored in the memory 22 and if it has not been previously used generates a control signal that operates the latch actuator 26 to open the lock 6. Alternatively the processor may write to the memory 22 each transaction-unique delivery key as it is used in order to create a list of invalid keys that can not be used to operate the lock again.

It is possible to use the system in various scenarios depending on the degree of control to be exercised by the scheme operator.

In the simplest scenario, the scheme operator has complete control and knowledge of the customers' master keys and generates the transaction-unique delivery keys at the request of the sellers. The scheme operator can maintain a central database of the registered master keys and customer identification data that contains data relating to previous transactions to prevent duplicate key generation. The seller transmits the master key and data relating to the transaction to the scheme operator for the transaction-unique delivery key to be generated on-line. Since the seller will normally need to obtain an on-line authorisation for the credit part of the transaction from its merchant acquirer, it would be possible for that merchant acquirer to provide the additional service of generating the transaction-unique delivery keys for its Internet sellers. It would also be possible for the scheme operator to be a credit card issuer and similarly provide the transaction-unique delivery key generation as part of the authorisation process and pass this extra data back to the seller via its usual merchant acquirer.

In an alternative scenario the scheme operator can be excluded from knowledge of the master key so that only the seller or his payment processor has access to this data. In this scenario the scheme operator generates a customer unique transaction number which is combined by the seller with the master key to generate the transaction-unique delivery key to be printed on the barcode.

In a third scenario, the scheme operator registers sellers and gives them each a supplier number. They then become licensed suppliers. The seller then generates the transaction-unique delivery key and barcode by means of an algorithm combining the supplier number, the credit card number (master key) and a transaction number. In order to ensure that several sellers belonging to the scheme do not generate identical transaction-unique delivery keys, the sellers registered with the scheme could receive a block of unique transaction numbers for each customer to be used by the seller to include with their own delivery data in the generation of transaction-unique delivery keys. This enables the seller to subsequently operate independently of both the scheme operator and other participants by generating the barcodes itself.

In order to avoid a direct link between a payment card number and delivery address an intermediate master key may be used in the process of generating the transaction-unique delivery key.

The processor 20 may also contain a timer to record the time a particular transaction-unique delivery key was presented to the barcode reader 10 in order to permit that key to remain valid for a predetermined short period. This would enable the carrier to reopen the lock if, for example, it was inadvertently closed before the delivery was complete or there were multiple packages to be stowed. However, for security the transaction-unique delivery key should be capable of opening the lock on only a single occasion to prevent barcodes or RFID tags on old packaging being used as a key.

The only key that can open the lock 6 on more than one occasion and at will is the master key. Since this will remain in the safe custody of the customer, he or she can collect the delivered goods at a convenient time.

### Variations

Whilst the embodiment has described the delivery key as a barcode to be read by a barcode reader, other forms of labelling and reading could be employed such as a radio frequency ID (RFID) tag discussed above in conjunction with a proximity detector as the reader, a magnetic strip and reader, a chip and reader, or even a number and keypad for manual entry.

The use of an RFID tag on the packaging has the added advantage that it can also be used in tracking the goods in transit as well as for opening the lock on delivery.

The process could operate in reverse for return of faulty or unwanted goods. The customer could use the master key online to send a return request to the seller. The seller would use the encryption algorithm function to generate a return key in exactly the same way as a new transaction-unique delivery key would be generated. This return key can be printed as a barcode or programmed into an RFID tag by the carrier and used to open the lock 6 to collect the goods placed in the delivery space for return by the customer.

Similarly whilst the embodiment has described use of the lock system by a seller, any service provider such as a laundry, or a business supplier for any type of business such as a stationary supplier or a law firm, could operate the same system to collect and deliver generating a transaction-unique delivery key for each visit.

The system can be used with all manner of payment cards including credit cards, charge cards, store cards and pre-payment cards such as the London Underground OYSTER (Trademark) card.

Although the embodiment has described a payment card being used to generate a master key, any number unique to the customer may be used, such as bank account number, company registration number or VAT number. The use of such keys would either require the use of a keypad to enter the master key into the lock or the generation of a barcode master key from the number for use by the customer.

A lock could also be supplied with several master key cards of its own, particularly for business use. Since these might not be treated with the same degree of care as a customer's own credit card, an additional layer of security could be programmed into the processor 20 of such locks. This could be a requirement for a particular item of identification to be presented to the lock either via the slot 8 or reader 10 prior to the delivery key. This identification could be a magnetic card carried by an authorised deliveryman. This type of added layer of security could be added to any of the locks described. Additional layers of security might be a condition of increased insurance cover for the contents of the container 2.

In the embodiment described above the secure container 2 is a separate container firmly attached to, or built into the customer's delivery address. Alternatively, the secure container 2 can be a fridge, garage, shed or the like having a door fitted with the lock 6 to provide access to the delivery space.

The container 2 can be insulated or refrigerated to permit delivery of fresh or frozen goods.

It will be appreciated that numerous other variations within the scope of the claims may be devised and the embodiments described are not intended to be limiting.

1. A combination lock providing access to a delivery space, which lock is always operable in response to at least one master key and also operable on a single occasion in response to a transaction-unique delivery key characterised in that the transaction-unique delivery key is generated from a portion of the master key, and in that the lock comprises processor means or validating the delivery key, means for releasing the lock in response to a valid delivery key, and storage means for identifying used delivery keys.

2. A lock as claimed in claim 1, wherein the delivery key opens the lock only once.

3. A lock as claimed in claim 1, wherein the delivery key allows re-opening of the lock during a predetermined time period after initial use.

4. A lock as claimed in claim 1, wherein the lock may be programmed by a payment card having a number, a portion of which then becomes a master key.

5. A lock as claimed in claim 1, wherein the releasing means comprises a barcode reader and the delivery key is a barcode.

6. A lock as claimed in claim 1 further comprising a card reader to enable a master key to operate the lock.

7. A secure container comprising a lock as claimed in claim 1 and fitted with means for advertising its presence.

8. A method for the secure delivery of goods to or from a customer having access to a delivery space secured with a combination lock as claimed in claim 1, comprising the steps of:
(i) programming the lock with a master key
(ii) ordering of goods or services by the customer from a seller using a master key;
(iii) generation of a transaction-unique delivery key from a portion of the master key and data identifying the seller and transaction;
(iv) printing of the delivery key onto the goods as a barcode;
(v) delivery of the goods to the secure container by a carrier;
(vi) reading of the delivery key by the lock;
(vii) release of the lock in response to a valid delivery key to enable the carrier to place goods into or remove them from the delivery space; and
(viii) storing data identifying the used delivery key in the lock.

9. A method as claimed in claim 8, wherein the generation step is carried out by a payment card issuer as part of an authorisation process.

10. A method as claimed in claim 8, wherein the generation step is carried out by a scheme operator.

11. A method as claimed in claim 8, wherein the generation step is carried out by a licensed supplier.

12. A method as claimed in claim 8, wherein the master key is generated from a payment card number.

13. A method as claimed in claim 12, wherein an intermediate key is used in the generation of the master key from the payment card number.
